(19) United States
(12) Patent Application Publication
(10) Pub. No.: US 2013/0261197 A1
(43) Pub. Date: Oct. 3, 2013

(54) Additive for Use in Wash Step of PET Recycling Process

(71) Applicants: Luigi Bacchiocchi, Novara (NO) (IT); Gianluca Pozzi, Vittuone (MI) (IT)

(72) Inventors: Luigi Bacchiocchi, Novara (NO) (IT); Gianluca Pozzi, Vittuone (MI) (IT)

(21) Appl. No.: 13/438,149

(22) Filed: Apr. 3, 2012

(51) Int. Cl. C08J 11/04; C08K 5/42; C08K 5/05

(52) U.S. Cl. 521/48; 106/499; 106/503

(57) ABSTRACT

An additive for use in a wash solution of a PET recycling process is described. The PET recycling process includes the steps of sorting the scrap PET to remove other materials, granulating or shredding the scrap PET to produce PET flakes, and washing the PET to remove contaminants. The Wash step comprises the steps of contacting the PET flakes with a wash solution comprising: (a) an alkali hydroxide; and (b) an additive comprising: (i) at least one non-ionic surfactant; (ii) at least one cationic surfactant; (iii) a hydrotrope; (iv) water, and (V) optionally, a solvent.

### FIELD OF THE INVENTION

The present invention relates generally to an additive usable in a polyethylene terephthalate (PET) recycling process.

### BACKGROUND OF THE INVENTION

Polyethylene terephthalate (PET) is a widely used resin with a broad range of applications, including widespread use in beverage containers and bottles. The widespread use and acceptance of PET is due in part to its ability to be used for food contact as well as its light weight relative to glass of comparable strength and its ability to resist breakage.

Over recent years, environmental pressures have increased along with a demand for the recycling of many materials, including PET plastics. Many of the applications for recycled PET are for relatively low specification products that use a mixture of thermoplastic resins or polymers (including PET). In these applications, removal of contaminants is not important. However; if PET containers are recycled to produce PET resins, it is desirable that the PET resin be suitable for the same applications as virgin PET. In addition, it is often desirable that the recycled resin be usable for food contact applications, and, as such, there are strict limits on the presence of contaminants.

Furthermore, a common source of recyclable material is post consumer curbside waste, and PET plastics originating from sorted collections of solid waste can be contaminated with a range of materials including other polymers, such as polyolefins, high density polyethylene (HDPE), metals, and particulate materials, adhesives, paper, inks and remnants of materials stored in the containers.

Various processes have been proposed over the years for recycling PET plastics, as described for example, in U.S. Pat. No. 5,203,359 to Fesmire et al., U.S. Pat. No. 4,033,907 to Wolf, and in International Pub. No. WO 01/21373 to Visy Plastics Pty LTD, the subject matter of each of which is herein incorporated by reference in its entirety.

Generally, recycling/reclamation processes for PET plastics include steps of grinding the waste materials to reduce bulk, segregating the various types of materials from each other before or after grinding, followed by washing prior to recycling for refabrication or, alternatively pyrolyzing for monomer recover or incinerating for energy recovery.

A typical PET recycling process generally comprises at least the following steps:

(1) Sorting;

(2) Granulation/shredding;

(3) Washing; and

(4) Drying.

(1) Sorting—scrap may come into the recycling facility as a mixture of materials including, for example, PET bottles, including clear, green, blue and some other colors, clear PVC bottles, HDPE bottles, glass bottles, aluminum cans and even stray polystyrenes trays or cups. However, the material that is subjected to the granulation step must be only PET, so the sorting step is critical. In addition, if PET bottles are received from curbside recycling, “other plastics” contamination is common and therefore must be sorted out.

The configuration and dimensions of the sorting apparatus will vary according to production rate, set up of the building, handling of garbage and other factors. Sorting methods that are widely used in PET bottle recycling systems include negative and positive sorting methods. The common meaning for “negative” is to separate out the materials that are recognized to be something different than PET. The common meaning for “positive” is to separate out the PET bottles themselves. For high capacity systems, a fully automatic “near infrared” (NIR) sorting machine may be used.

At this point, the bottles (or other containers) are separated, by type of plastic and color, and are at least substantially metals and foreign objects free. The now separated PET bottles are then ready for the granulation step.

(2) Granulation—the granulation step involves downsizing the PET bottles or containers by granulating or shredding to flakes of a desired size. Both wet and dry granulators may be used, alone or in combination.

During the cutting action, the granulator removes, by friction, at least portions of the labels sticking to the surface of the PET flakes. It is also common for the PET flakes to go through a device to separate the labels from the heavier PET flakes. Thus, after the PET material is separated from other such plastics, metals, and paper (including labels), the granulated PET material is ready for the washing step.

(3) Washing—in the washing step, the PET flakes are typically subjected to a pre-washing step in which a horizontal centrifuge or other similar type device, working with water in the first part and a dryer in the second part, is used to at least substantially remove paper and surface dirt from the PET flakes.

In addition, the granulated PET flakes may also be subjected to a sink-float tank with agitation (or another similar device known in the art) to remove floatable materials such as low density polyethylene (LDPE) and polypropylene (PP) labels from the PET flakes.

After the optional (but preferable) steps of pre-washing and separation from olefins, the PET flakes are washed using a caustic solution, such as sodium hydroxide, alone or in combination with a detergent, at an elevated temperature. During the wash step, the PET flakes are contacted with the hot caustic solution at a temperature of from about 130° to 200° F. for a predetermined time period. This hot caustic wash destroys mold growth and bacteria, which could result in a failure of the recycled material to meet Public Health standards, and dissolves metallic contaminants, such as aluminum caps and label foil, which may have been carried over from the sorting step.

After washing, the PET flakes are thoroughly rinsed to remove all of the caustic solution. Finally, the PET flakes are dried.

If the PET flakes are designated for food applications, additional steps may be required to meet standards for contamination and to adjust the pH to about 7.

### SUMMARY OF THE INVENTION

It is an object of the present invention to control foam during the washing step of a PET recycling process.

It is another object of the present invention to provide an improved means of sludge separation during the washing step of a PET recycling process.

It is still another object of the present invention to provide an improved additive for use in the wash step of a PET recycling process.

To that end, the present invention relates generally to an additive for use in a wash step of a PET recycling process, the additive comprising:

a) at least one non-ionic surfactant;

b) at least one cationic surfactant;

c) a hydrotrope;

d) water; and

e) optionally, an organic solvent.

In another embodiment, the present invention relates generally to a process for recycling scrap polyethylene terephthlate, the process including the steps of sorting the scrap polyethylene terephthalate to remove other materials, granulating or shredding the scrap polyethylene terephthalate to produce polyethylene terephthalate flakes, and washing the polyethylene terephthalate flakes to remove contaminants, wherein the wash step comprises the steps of

contacting the polyethylene terephthalate flakes with a wash solution comprising:

a) an alkali hydroxide; and

b) an additive comprising:
i) at least one non-ionic surfactant;
ii) at least one cationic surfactant;
iii) a hydrotrope;
iv) water; and
v) optionally, an organic solvent; and thereafter

rinsing and drying the polyethylene terephthalate flakes.

### DETAILED DESCRIPTION OF THE PREFERRED EMBODIMENTS

The inventors of the present invention have found that the use of an additive in the caustic washing solution provides good results in terms of foam control and sludge separation. The use of this additive in the caustic washing solution helps to control the foam that results from saponification between caustics and organic pollution from bottles and to separate the sludges that may form.

In one embodiment, the present invention relates generally to an additive for use in a wash step of a PET recycling process, the additive comprising:

a) at least one non-ionic surfactant;

b) at least one cationic surfactant;

c) a hydrotrope;

d) water; and

e) optionally, an organic solvent.

While various organic solvents are usable in the practice of the present invention, the solvent is preferably a glycol ether. Suitable glycol ethers include, but are not limited to, ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, diethylene glycol monomethyl ether, diethylene glycol monoethyl ether, diethylene glycol mono-n-butyl ether, ethylene glycol dimethyl ether, ethylene glycol diethyl ether, ethylene glycol dibutyl ether, and combinations of one or more of the foregoing. In a preferred embodiment, the glycol ether comprises diethylene glycol mono-n-butyl ether (also known as butyl diglycol).

The concentration of the solvent in the additive is typically in the range of about 2-8% by weight, more preferably in the range of about 3-6% by weight and most preferably in the range of about 3-4% by weight, based on the total weight of the additive.

Useful non-ionic surfactants include the condensation products of aliphatic alcohols with from about 1 to about 60 moles of ethylene oxide. The alkyl chain of the aliphatic alcohol can either be straight or branched, primary or secondary, and generally contains from about 8 to about 22 carbon atoms. Examples of such ethoxylated alcohols include the condensation product of myristyl alcohol condensed with about 10 moles of ethylene oxide per mole of alcohol and the condensation product of about 9 moles of ethylene oxide with coconut alcohol (a mixture of fatty alcohols with alkyl chains varying in length from about 10 to 14 carbon atoms). Other examples are those C₆-C₁₁ straight-chain alcohols which are ethoxylated with from about 3 to about 6 moles of ethylene oxide. Their derivation is well known in the art. One example of an ethoxylated fatty alcohol that is usable in the additive described herein is available from Sasol Company under the tradename, BIODAC® 610.

Further useful nonionic surfactants include alcohol ethoxylates and alcohol alkoxylates. Other examples of useful nonionic surfactants include those having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12.

Another class of useful nonionic surfactants include are monobranched alkoxylated C10-fatty alcohols and/or C11-fatty alcohols; these are jointly referred to as C10/C11-fatty alcohols. While the foregoing materials are ethoxylated, it is to be understood that other alkoxylated, e.g., propoxylated, butoxylated, as well as mixed ethoxylated and propoxylated branched nonionic alkyl polyethylene glycol ether may also be used. One suitable ethoxylated/propoxylated fatty alcohol is available from Sasol Company under the tradename BIODAC® 2-32, which has been demonstrated to have good alkaline stability and is a low-foam surfactant.

Suitable non-ionic surfactants also include alcohol ethoxylate and alcohol alkoxylate surfactants. Suitable alkoxylated surfactants include EO/PO copolymers, capped EO/PO copolymers, alcohol alkoxylates, capped alcohol alkoxylates, mixtures thereof, or the like, such as MARLOX® OP1 (R-(EO)₆(PO)₄) and Dehypon LS-36 (R-(EO)₃(PO)₆); and capped alcohol alkoxylates, such as Plurafac LF231 and Tegoten EC11; mixtures thereof, or the like.

The concentration of the at least one non-ionic surfactant in the additive is typically in the range of about 45-65% by weight, more preferably in the range of about 50-60% by weight and most preferably in the range of about 53-58% by weight, based on the total weight of the additive. In an especially preferred embodiment, at least two non-ionic surfactants are used—an ethoxylated fatty alcohol in an amount of about 45-55% by weight, more preferably about 50% by weight and an ethoxylated/propoxylated fatty alcohol in an amount of about 4-10% by weight, more preferably about 5% by weight.

The at least one cationic surfactant usable in the additive described herein is preferably a quaternary ammonium compound. These quaternary ammonium compounds may also act as germicides. Especially preferred are quaternary ammonium compounds and salts thereof, which may be characterized by the general structural formula:

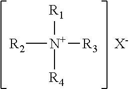

where at least one of R₁, R₂, R₃ and R₄ is a alkyl, aryl or alkylaryl substituent of from 6 to 26 carbon atoms, and the entire cation portion of the molecule has a molecular weight of at least 165. The alkyl substituents may be long-chain alkyl, long-chain alkoxyaryl, long-chain alkylaryl, halogen-substituted long-chain alkylaryl, long-chain alkylphenoxyalkyl, arylalkyl, etc. The remaining substituents on the nitrogen atoms other than the abovementioned alkyl substituents are hydrocarbons usually containing no more than 12 carbon atoms. The substituents R₁, R₂, R₃ and R₄ may be straight-chained or may be branched, but are preferably straight-chained, and may include one or more amide, ether or ester linkages. The eounterion. X may be any salt-forming anion which permits water solubility of the quaternary ammonium onium complex.

Exemplary quaternary ammonium salts within the above description include the alkyl ammonium halides such as cetyl trimethyl ammonium bromide, alkyl aryl ammonium halides such as octadecyl dimethyl benzyl ammonium bromide, N-alkyl pyridinium halides such as N-cetyl pyridinium bromide, and the like. Other suitable types of quaternary ammonium salts include those in which the molecule contains either amide, ether or ester linkages such as octyl phenoxy ethoxy ethyl dimethyl benzyl ammonium chloride, N-(laurylcocoaminoformylmethyl)-pyridinium chloride, and the like. Other very effective types of quaternary ammonium compounds which are useful as germicides include those in which the hydrophobic radical is characterized by a substituted aromatic nucleus as in the case of lauryloxyphenyltrimethyl ammonium chloride, cetylaminophenyltrimethyl ammonium methosulfate, dodecylphenyltrimethyl ammonium methosulfate, dodecylbenzyltrimethyl ammonium chloride, chlorinated dodecylbenzyltrimethyl ammonium chloride, and the like.

Preferred quaternary ammonium compounds which act as germicides and which have been found to be useful in the practice of the present invention include those which have the structural formula:

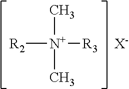

wherein R₂ and R₃ are the same or different C₈-C₁₂ alkyl, or R₂ is C₁₂₋₁₆ alkyl, C₈₋₁₈ alkylethoxy, C₈₋₁₈ alkylphenolethoxy and R₃ is benzyl, and X is a halide, for example chloride, bromide or iodide, or is a methosulfate anion. The alkyl groups recited in R₂ and R₃ may be straight-chained or branched, but are preferably substantially linear.

Particularly useful quaternary germicides include compositions which include a single quaternary compound, as well as mixtures of two or more different quaternary compounds. Such useful quaternary compounds are available under the BARDAC®, BARQUAT®, HYAMINE®, LONZABAC®, BTC® and ONYXIDE® trademarks, which are more fully described in the respective product literature from the suppliers identified below. For example, BARDAC® 205M is described to be a liquid containing alkyl dimethyl benzyl ammonium chloride, octyl decyl dimethyl ammonium chloride; didecyl dimethyl ammonium chloride, and dioctyl dimethyl ammonium chloride (50% active) (also available as 80% active (BARDAC® 208M)); BARDAC® 2050 is described to be a combination of octyl decyl dimethyl ammonium chloride/didecyl dimethyl ammonium chloride, and dioctyl dimethyl ammonium chloride (50% active) (also available as 80% active (BARDAC® 2080)); BARDAC® 2250 is described to be didecyl dimethyl ammonium chloride (50% active); BARDAC® LF (or BARDAC® LF-80), described as being based on dioctyl dimethyl ammonium chloride (BARQUAT® MB-50, MX-50, OJ-50 (each 50% liquid) and BARDAC® MB-80 or MX-80 (each 80% liquid) are each described as an alkyl dimethyl benzyl ammonium chloride; BARDAC® 4250 and BARQUAT® 4250Z (each 50% active) or BARQUAT® 4280 and BARQUAT® 4280Z (each 80% active) are each described as alkyl dimethyl benzyl ammonium chloride/alkyl dimethyl ethyl benzyl ammonium chloride. Also, HYAMINE® 1622, described as diisobutyl phenoxy ethoxy ethyl dimethyl benzyl ammonium chloride (50% solution); HYAMINE® 3500 (50% actives), described as alkyl dimethyl benzyl ammonium chloride (also available as 80% active (HYAMINE® 3500-80)); and HYMAINE® 2389 described as being based on methyldodecylbenzyl ammonium chloride and/or methyldodecylxylene-bis-trimethyl ammonium chloride. (BARDAC®, BARQUAT® and HYAMINE® are presently commercially available from Lonza, Inc., Fairlawn, N.J.). BTC® 50 NF (or BTC® 65 NF) is described to be alkyl dimethyl benzyl ammonium chloride (50% active); BTC® 99 is described as didecyl dimethyl ammonium chloride (50% active); BTC® 776 is described to be myrisalkonium chloride (50% active); BTC® 818 is described as being octyl decyl dimethyl ammonium chloride, didecyl dimethyl ammonium chloride, and dioctyl dimethyl ammonium chloride (50% active) (available also as 80% active (BTC® 818-80%)); BTC® 824 and BTC® 835 are each described as being of alkyl dimethyl benzyl ammonium chloride (each 50% active); BTC® 885 is described as a combination of BTC® 835 and BTC® 818 (50% active) (available also as 80% active (BTC® 888)); BTC® 1010 is described as didecyl dimethyl ammonium chloride (50% active) (also available as 80% active (BTC® 1010-80)); BTC® 2125 (or BTC® 2125 M) is described as alkyl dimethyl benzyl ammonium chloride and alkyl dimethyl ethylbenzyl ammonium chloride (each 50% active) (also available as 80% active (BTC® 2125 80 or BTC® 2125 M)); BTC® 2565 is described as alkyl dimethyl benzyl ammonium chlorides (50% active) (also available as 80% active (BTC® 2568)); BTC® 8248 (or BTC® 8358) is described as alkyl dimethyl benzyl ammonium chloride (80% active) (also available as 90% active (BTC® 8249)); ONYXIDE® 3300 is described as n-alkyl dimethyl benzyl ammonium saccharinate (95% active). (BTC® and ONYXIDE® are presently commercially available from Stepan Company, Northfield, Ill.) Polymeric quaternary ammonium salts based on these monomeric structures are also considered desirable for the present invention. One example is POLYQUAT®, described as being a 2-butenyldimethyl ammonium chloride polymer. One especially preferred quaternary ammonium compound comprises N,N Dimethyl 2-hydroxypropylamnouium chloride available under the tradename ROQUAT® JL.

The concentration of the quaternary ammonium compound in the additive is typically in the range of about 2-10% by weight, more preferably in the range of about 4-8% by weight and most preferably in the range of about 5% by weight, based on the total weight of the additive.

The additive described herein also preferably comprises a hydrotrope to maintain product stability or homogeneity over wide temperature ranges. As used herein the terms “hydrotrope” and “hydrotropic compound” refer to benzene sulfonates, naphthalene sulfonates, short chain (C₁₋₁₁) alkyl benzene sulfonates, medium chain (C₆₋₁₁) alkyl sulfonates, medium chain (C₆₋₁₁) alkyl sulfates, alkylpolyglucosides, medium chain (C₆-C₁₀) alkyl dimethyl amine oxides, alkyl diphenyloxide disulfonates, phosphate ester hydrotropes, and medium chain (C₆₋₁₁) alkyl ether (up to 10 moles of ethylene oxide) sulfates. The cations of the hydrotropic compounds of the invention include alkali metal, ammonium, and triethanolammonium cations. Thus, these terms include short-chain water-soluble surfactants which comprise a hydrophilic substituent and one or more hydrophobic hydrocarbyl substituents wherein the maximum chain length of any of said hydrocarbyl substituents is about C₁₁.

Short chain (C₁₋₄) alkyl benzene sulfonates include, for example, isopropylbenzene sulfonates, xylene sulfonates, toluene sulfonates, cumene sulfonates, and mixtures thereof. Representative, non-limiting examples of medium chain (C₆₋₈) alkyl sulfonates are hexyl sulfonates, octyl sulfonates, and hexyl/octyl sulfonates, and mixtures thereof. Other hydrotropes are naphthalene sulfonates.

The terms “hydrotrope” and “hydrotropic compound” also refer to alkylpolysaccharides such as alkylpolyglycosides, polymeric hydrotropes, C₈₋₁₀ amine oxides, alkyldiphenyloxide disulfonates, and phosphate esters such, as isopropanol alkyl phosphate esters, and the like.

Preferred hydrotropes for use in the invention are xylene sulfonates, cumene sulfonates, alkyl sulfonates having from an average of about 6-8 carbon atoms in the alkyl portion, and alkylpolyglycosides having an average of about 10 carbon atoms in the alkyl portion. One particularly preferred hydrotrope is sodium cumen sulfonate.

The concentration of the hydrotrope in the additive is typically in the range of about 2-10% by weight, more preferably in the range of about 4-8% by weight and most preferably in the range of about 5% by weight, based on the total weight of the additive.

Finally, the balance of additive comprises water. In a preferred embodiment, deionized water is used at a concentration of between about 25 to about 40% by weight, more preferably between about 30-35% by weight.

In another embodiment, the present invention also relates generally to a process for recycling scrap polyethylene terephthlate, the process including the steps of sorting the scrap polyethylene terephthalate to remove other materials, granulating or shredding the scrap polyethylene terephthalate to produce polyethylene terephthalate flakes, and washing the polyethylene terephthalate flakes to remove contaminants, wherein the wash step comprises the steps of

contacting the polyethylene terephthalate flakes with a wash solution comprising:

a) an alkali hydroxide; and

b) an additive comprising:
i) at least one non-ionic surfactant;
ii) at least one cationic surfactant; iii) a hydrotrope;
iv) water; and
v) optionally, an organic solvent; and thereafter

rinsing and drying the polyethylene terephthalate flakes.

In a preferred embodiment, the alkali hydroxide comprises sodium hydroxide. The alkali hydroxide is preferably used in the wash solution at a concentration of about 0.5 to about 2.0% by weight of the alkali hydroxide.

The wash solution also comprises about 1 to about 3 grams/liter of the additive.

In addition, it is desirable that the wash step is conducted at an elevated temperature. In a preferred embodiment, the wash step is conducted at a temperature of between about 60 to about 90° C.

### Example 1

A composition in accordance with the invention was prepared comprising:

| Ingredient | Composition | % by Wt. |
|---|---|---|
| Deionized water | | 32 |
| Butyl diglycol | | 3 |
| BIODAC ® 610 | Ethoxylated fatty alcohol | 50 |
| Sodium cumen sulfonate (40%) | | 5 |
| GENAPOL ® E280 | Ethoxylated fatty alcohol | 5 |
| ROQUAT ® JL | ammonium quaternary salt | 5 |

This additive was used added to a caustic (NaOH) in the wash step under the following conditions:

| | |
|---|---|
| Temperature: | 60-90° C. |
| NaOH (30%) | 0.5 to 2% |
| Additive | 1-3 g/l. |

The use of this additive in the caustic washing solution was shown to provide good results in terms of both foam control and sludge separation.

It is also to be understood that the following claims are intended to cover all of the generic and specific features of the invention described herein and all statements of the scope of the invention which as a matter of language might fall therebetween.

1-13. (canceled)

14. A process for recycling scrap polyethylene terephthalate, the process including the steps of sorting the scrap polyethylene terephthalate to remove other materials, granulating or shredding the scrap polyethylene terephthalate to produce polyethylene terephthalate flakes, and washing the polyethylene terephthalate flakes to remove contaminants, wherein the wash step comprises the steps of:
contacting the polyethylene terephthalate flakes with a wash solution comprising:
a) an alkali hydroxide; and
b) an additive comprising:
i) at least one non-ionic surfactant;
ii) at least one cationic surfactant;
iii) a hydrotrope selected from the group consisting of benzene sulfonates, naphthalene sulfonates, short chain (C1-C11) alkyl benzene sulfonates, medium chain (C6-C11) alkyl sulfonates, medium chain (C6-C11) alkyl sulfates, alkylpolyglucosides, alkylpolysaccharides, medium chain (C6-C10) alkyl dimethyl amine oxides, alkyl dimethyl amine oxides, alkyl diphenyloxide disulfonates, and phosphate esters;
iv) balance, water; and
v) optionally an organic solvent; and thereafter
rinsing and drying the polyethylene terephthalate flakes.

15. The process according to claim 14, wherein the alkali hydroxide comprises sodium hydroxide.

16. The process according to claim 14, wherein the wash solution comprises about 0.5 to about 2.0% by weight of the alkali hydroxide.

17. The process according to claim 14, wherein the wash solution comprises about 1 to about 3 grams/liter of the additive.

18. The process according to claim 14, wherein the wash step is conducted at a temperature of between about 60 to about 90° C.

19. The process according to claim 14, wherein the additive comprises an organic solvent selected from the group consisting of ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, diethylene glycol monomethyl ether, diethylene glycol monoethyl ether, diethylene glycol mono-n-butyl ether, ethylene glycol dimethyl ether, ethylene glycol diethyl ether, ethylene glycol dibutyl ether, and combinations of one or more of the foregoing.

20. The process according to claim 19, wherein the organic solvent comprises diethylene glycol mono-n-butyl ether.

21. The process according to claim 14, wherein the at least one cationic surfactant comprises a quaternary ammonium salt.

22. The process according to claim 21, wherein the quaternary ammonium salt comprises the general structural formula: 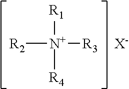
wherein at least one of R₁, R₂, R₃ and R₄ is a alkyl, aryl or alkylaryl substituent of from 6 to 26 carbon atoms, X⁻ is a salt-forming anion which permits water solubility of the quaternary ammonium complex, and the entire cation portion of the molecule has a molecular weight of at least 165.

23. The process according to claim 22, wherein the quaternary ammonium salt comprises dioctyl dimethyl ammonium chloride.

24. The process according to claim 14, wherein the hydrotrope is selected from the group consisting of xylene sulfonates, cumene sulfonates, alkyl sulfonates having from an average of about 6-8 carbons in the alky portion and alkylpolyglycosides

25. The process according to claim 24, wherein the hydrotrope comprises sodium cumene sulfonate.

26. The process according to claim 21, wherein the cationic surfactant comprises a mixture of at least two different quaternary ammonium compounds.

27. The process according to claim 14, wherein the nonionic surfactant comprises a mixtures of at least two different non-ionic surfactants.

28. The process according to claim 14, wherein the non-ionic surfactant comprises an ethoxylated/propoxylated fatty alcohol.
